(19) United States
(12) Patent Application Publication
(10) Pub. No.: US 2021/0235530 A1
(43) Pub. Date: Jul. 29, 2021

(54) User Device Communications Audio Link Recovery

(71) Applicant: QUALCOMM Incorporated, San Diego, CA (US)

(72) Inventors: Hari Om GOYAL, Hyderabad, IN (US); Venkat Ramana Sugamanchi, Hyderabad (IN); Rashmi Ranjan Padhi, Hyderabad (IN); Suryakanta Mandal, Hyderabad (IN); Kihak Yi, Hyderabad (IN)

(21) Appl. No.: 16/773,179

(22) Filed: Jan. 27, 2020

(51) Int. Cl. H04W 76/19

(52) U.S. Cl. CPC H04W 76/19

(57) ABSTRACT

Methods executed by a processor of a user equipment for recovering a communication audio link during a voice call are disclosed. The processor of the user equipment may detect a potential audio link codec problem during an active voice call based on an audio link pattern, determine whether the detected potential audio link codec problem is resolved before expiration of a failure declaration timer that was started in response to detecting the potential audio link codec problem, and initiating a radio link failure recovery procedure in response to determining that the detected potential audio link codec problem has not been resolved before expiration of the failure declaration timer. The failure declaration timer may be started in response detecting any of a repeating homing sequence, repeating data sequences, threshold data or packet loss, receipt of undecodable patterns in vocoder data, or jitter in vocoder output.

### BACKGROUND

During mobile voice calls, often users encounter circumstances in which sound is muted to one party or the other. These audio problems may occur intermittently or for extended periods, but when users encounter these problems, they often hang up and try to reinitiate the call, which can be frustrating when the other party is still on the line.

Increasingly, momentary interruptions in audio in wireless telephone calls are caused by changes in the audio coder/decoder (“codec”) or voice encoder (“vocoder”) used to encode and decode audio information from the data communicated over the wireless communication link. As a legacy from how cellular communications evolved, there are now several different codecs in use, including codecs developed for 2G service, codecs developed for 3G service and now codecs developed for various types of wireless service available in 5G networks. When the wireless service level (i.e., the radio link) changes, such as when a smartphone moves through a service area, the codec or vocodor used to encode and decode sound data (referred to as the “audio link”) may also change. Vocoder type and data rate changes happen frequently when multi-radio access technologies (RATs) are involved (e.g., NR, 4G, 3G, and 2G/CSFB) in a given service area, and a call undergoes changes in network configuration, signal variation, handover, etc. Changing the audio link can cause delays in sound, result in the audio link becoming stuck in a vocoder reset, the audio link sending repetitive patterns (e.g., sending homing sequences to adapt to new codec rate changes), and the audio link exhibiting jitter. While such problems usually resolve in a matter of just a few seconds, sometimes the audio link fails to reestablish quickly enough to prevent callers from presuming the call has been dropped. The growing list of codecs in use means there are more opportunities for calls to go silent while an audio link change happens, and thus more times that one party will presume the call has dropped and redial while the other party remains on the call.

### SUMMARY

Various aspects include methods for recovering a communication audio link of a user equipment with a communication network.

One aspect of the present disclosure relates to a method performed by a processor of a user equipment for recovering a communication audio link with a communication network. Various aspects may include detecting a potential audio link codec problem occurs for an active voice call based on an audio link pattern, determining whether the detected potential audio link codec problem is resolved before expiration of a failure declaration timer started in response to detecting the potential audio link codec problem, and initiating a radio link failure recovery procedure in response to determining that the detected potential audio link codec problem is not resolved before expiration of the failure declaration timer.

In some aspects, the potential audio link codec problem may be at least one of a repeating homing sequence, threshold data or packet loss, receipt of undecodable patterns in vocoder data, or jitter in vocoder output.

Some aspects may further include initiating the failure declaration timer in response to detecting a potential audio link codec problem.

In some aspects, the failure declaration timer may include a plurality of timers run one after the other in an uninterrupted series and expiration of the failure declaration timer occurs when a last in the series of the plurality of timers expires. In such aspects, durations of each of the plurality of timers may be based on a type of detected potential audio link codec problem associated with each timer.

Some aspects may further include incrementing an audio link failure counter in response to expiration of each of a series of timers, in which initiating the radio link failure recovery procedure may be further in response to the audio link failure counter reaching a threshold.

Some aspects may further include decrementing the audio link failure counter in response to determining that the detected potential audio link codec problem has been resolved before expiration of the failure declaration timer.

In some aspects, the failure declaration timer may be set to a duration that depends on a type of the detected potential audio link codec problem.

In some aspects, the failure declaration timer may include a separate timer for each type of detected potential audio link codec problem and initiating the radio link failure recovery procedure is performed in response to expiration of any of the separate timers.

Various aspects may be implemented in communication networks using any of a variety of RATs, and detecting a potential audio link codec problem during the active voice call based on an audio link pattern may involve detecting the potential audio link codec problem following a change in the RAT during the active voice call, including a change from a packet switch communication protocol to a circuit switch communication protocol.

Further aspects may include a user equipment having a processor configured to perform operations of any of the methods summarized above. Further aspects may include a processor configured for use a user equipment and configured with processor-executable instructions to perform operations of any of the methods summarized above. Further aspects may include a non-transitory processor-readable storage medium having stored thereon processor-executable instructions configured to cause a processor of a user equipment to perform operations of any of the methods summarized above. Further aspects include a user equipment having means for performing functions of any of the methods summarized above. Further aspects include a system on chip for use in a user equipment that includes a processor configured to perform one or more operations of any of the methods summarized above. Further aspects include a system in a package that includes two systems on a chip for use in a user equipment that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a system block diagram conceptually illustrating an example communications system including a small cell and problems that can develop in such systems.

FIG. 2 is a component block diagram illustrating a computing system that may be configured to implement management of cell selection in accordance with various embodiments.

FIG. 3 is a diagram illustrating an example of a software architecture including a radio protocol stack for the user and control planes in wireless communications in accordance with various embodiments.

FIG. 4 is a component block diagram illustrating a system configured for recovering a communication audio link of a user equipment with a communication network in accordance with various embodiments.

FIGS. 5A and 5B illustrate operations of methods for recovering a communication audio link of a user equipment with a communication network in accordance with various embodiments.

FIGS. 6A, 6B, 6C, and/or 6D illustrate(s) operations of methods for recovering a communication audio link of a user equipment with a communication network in accordance with various embodiments.

FIG. 7 is a component block diagram of a wireless communication device suitable for recovering a communication audio link of a user equipment with a communication network in accordance with various embodiments.

FIG. 8 is a component block diagram of a wireless router device suitable for recovering a communication audio link of a user equipment with a communication network in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Methods for recovering a communication audio link of a user equipment with a communication network are disclosed. Various embodiments include detecting, by a processor of the user equipment, when a potential audio link codec problem occurs for an active voice call based on an audio link pattern, and determining whether the detected potential audio link codec problem is resolved before expiration of a failure declaration timer that was started in response to detecting the potential audio link codec problem. In response to determining the detected potential audio link codec problem is not resolved before expiration of the failure declaration timer, the processor may initiate a radio link failure recovery procedure, which speeds recovery of audio communications, thereby improving the user experience.

As used herein, the expression “potential audio link codec problem” refers to detected abnormal audio link codec patterns that are more likely than not to noticeably impair a user experience during an active voice call. For example, abnormal audio link codec patterns may be detected from a repeating homing sequence, repeating data sequence, threshold data or packet loss, receipt of undecodable patterns in vocoder data, and/or jitter in the vocoder output.

The term “user equipment” is used herein to refer to any one or all of wireless router devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, user equipment affixed to or incorporated into various mobile platforms, global positioning system devices, and similar electronic devices that include a memory, wireless communication components and a programmable processor configured to support audio communications, such as phone calls via a wireless communication network.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single user equipment. The proximity of the SOCs facilitates high speed communications and the sharing of memory and resources.

The term “multicore processor” may be used herein to refer to a single integrated circuit (IC) chip or chip package that contains two or more independent processing cores (e.g., CPU core, Internet protocol (IP) core, graphics processor unit (GPU) core, etc.) configured to read and execute program instructions. A SOC may include multiple multicore processors, and each processor in an SOC may be referred to as a core. The term “multiprocessor” may be used herein to refer to a system or device that includes two or more processing units configured to read and execute program instructions.

Various embodiments include methods and user equipment (UE) (e.g., smartphones) implementing the methods to recognize in the UE, as opposed to in the network, when an audio link codec problem is happening. In the event that an audio link codec problem is detected and is not resolved within a brief period of time, consistent with a normal audio link recovery, the user equipment may take an action to resolve the audio link codec problem by initiating a radio link failure (RLF) recovery procedure. Various embodiments may involve monitoring for various types of problems that are commonly caused by an audio link change over. When one or more of those types of problems is/are detected, a timer or a series of timers (referred to herein as failure declaration timer(s)) may be started. The duration measured by the timer(s) may be based on how long it normally takes to resolve the detected type of audio link problem or problems. If the detected audio link problem or problems is/are not resolved within the preset amount of time measured by the failure declaration timer(s), the processor of the user equipment may initiate the RLF recovery procedure. The RLF recovery procedure will switch the call to a different base station, thus keeping the call alive and reestablishing the audio link. As a result, interruptions in sound due to an audio link failure may be kept brief, thereby improving the user experience. Without initiating the RLF recovery procedure in this way, the call might otherwise continue to have noticeable audio link problems since contemporary UEs do not have a way of initiating an RLF recovery procedures, other than disconnecting the call.

In various embodiments, abnormal patterns detected by the user equipment in the audio link may indicate that an audio link issue is developing that could lead to an audio link failure. By detecting the abnormal patterns and preemptively initiating a radio link failure recovery procedure, various embodiments may help better coordinate codecs and solve any audio link problems before a user attempts to solve the problem on their own. Detecting abnormal patterns in the audio link may include detecting a repeated homing sequence, repetitive data sequences, durations when no data is received due to data/packet loss, receipt of undecodable patterns in vocoder data, and jitter in the vocoder output (i.e., the audio packets are delayed or received as a burst due to network congestion). A separate monitor or test on the data flowing through the audio link may detect when any of these abnormal patterns appears.

In response to the modem detecting an abnormal pattern in the audio quality of a call, a processor of the user equipment may start a failure declaration timer, which may be associated with or specific to the detected abnormal pattern. The failure declaration timer may be set to expire at or just longer than the time it typically takes for the audio link problem associated with the detected abnormal pattern to be resolved if there is no failure in the audio link. For example, an issue causing repetitions of the homing sequence should result in the vocoders synchronizing to reestablish the audio link in approximately three seconds or less. If the failure declaration timer expires (or a series of failure declaration timers) expire before the audio link problem is resolved, this may indicate that the audio link problem is unlikely to be resolved soon enough to avoid impacting the user experience. For example, if the processor detects repetitions of the homing sequence and the vocoders do not synchronize before expiration of the associated failure detection timer, this may indicate that it could be several seconds (if ever) before the audio link can resynchronize, which is long enough that one party or the other may conclude that the call has been dropped and hang up. Therefore, upon expiration of the associated failure declaration timer(s) the processor of the user equipment may initiate the RLF recovery procedure, which quickly switches the call to a different base station unit, resulting in establishment of a new radio link and a new audio link.

Various embodiment may improve the user experience for users of mobile wireless communications in situations in which changes in the vocoder occur. Various embodiments may be employed in communication systems using any radio access technology (RAT), which is beneficial because audio link codec problems that may arise during an inter-RAT handover or transition, as well as in response to inter-codec rate changes, codec bypass, signal variations and “fallback” procedures in which the user equipment and/or the network switches from packet switch communications to circuit switch communications in response to network limitations. Thus, various embodiments may particularly improve the user experience when moving through coverage areas that employ different RATs associated with different vocoders. Promptly resolving an audio link problem in this way may reduce the likelihood that users experiencing an audio link problem will prematurely hang-up (i.e., end) the active voice call and attempt to call back the other party, which causes both delays and interruptions in a call. Reducing the occurrence of premature hang-ups due to audio link problems, may reduce occasions when the two parties to a telephone call attempt to call each other back at the same time, resulting in both parties receiving a busy signal, which further delays and/or interrupts a phone call.

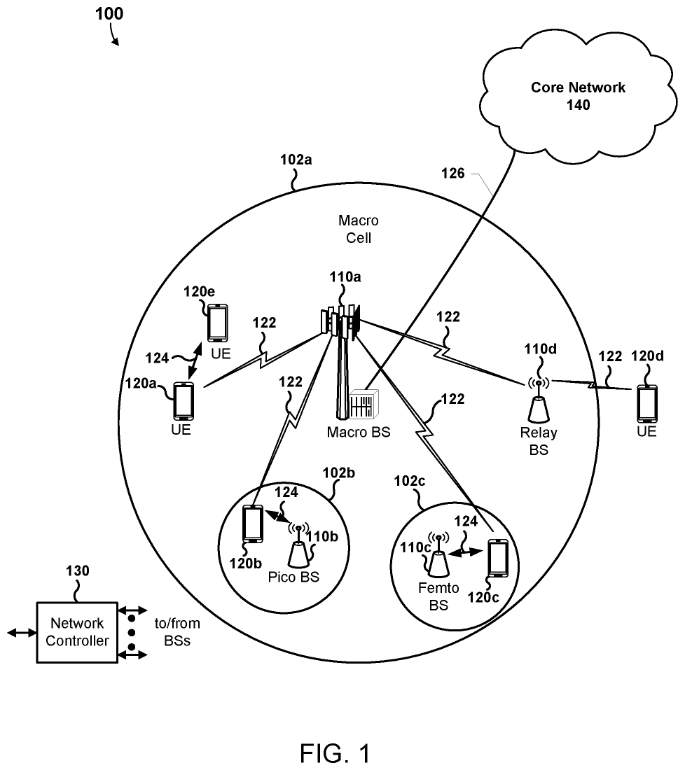

FIG. 1 illustrates an example of a communications system 100 that is suitable for implementing various embodiments. The communications system 100 may be a 5G NR network, or any other suitable network such as an LTE network.

The communications system 100 may include a heterogeneous network architecture that includes a core network 140 and a variety of mobile devices (illustrated as user equipment 120a-120e in FIG. 1). The communications system 100 may also include a number of base stations (illustrated as the BS 110a, the BS 110b, the BS 110c, and the BS 110d) and other network entities. A base station is an entity that communicates with user equipment (mobile devices), and also may be referred to as an NodeB, a Node B, an LTE evolved nodeB (eNB), an access point (AP), a radio head, a transmit receive point (TRP), a New Radio base station (NR BS), a 5G NodeB (NB), a Next Generation NodeB (gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by mobile devices with service subscription. A pico cell may cover a relatively small geographic area and may allow unrestricted access by mobile devices with service subscription. A femto cell may cover a relatively small geographic area (for example, a home) and may allow restricted access by mobile devices having association with the femto cell (for example, mobile devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The user equipment 120a-120e may communicate with the base station 110a-110d over a wireless communication link 122.

The wired or wireless communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (e.g., relay BS 110d). A relay station is an entity that can receive a transmission of data from an upstream station (for example, a base station or a mobile device) and send a transmission of the data to a downstream station (for example, user equipment or a base station). A relay station also may be a mobile device that can relay transmissions for other user equipment. In the example illustrated in FIG. 1, a relay station 110d may communicate with macro the base station 110a and the user equipment 120d in order to facilitate communication between the base station 110a and the user equipment 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The user equipment 120a, 120b, 120c may be dispersed throughout communications system 100, and each user equipment may be stationary or mobile. A user equipment also may be referred to as an access terminal, a terminal, a mobile station, a subscriber unit, a station, etc.

A macro base station 110a may communicate with the core network 140 over a wired or wireless communication link 126. The user equipment 120a, 120b, 120c may communicate with a base station 110a-110d over a wireless communication link 122.

The wireless communication links 122, 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include2G, 3G, 4G, 3GPP LTE, 5G (e.g., new radio (NR)), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links 122, 124 within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth may also be partitioned into sub-bands. For example, a sub-band may cover 1.08 MHz (i.e., 6 resource blocks), and there may be 1, 2, 4, 8 or 16 sub-bands for system bandwidth of 1.25, 2.5, 5, 10 or 20 MHz, respectively.

While descriptions of some embodiments may use tell sinology and examples associated with LTE technologies, various embodiments may be applicable to other wireless communications systems, such as an NR or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported, and beam direction may be dynamically configured. Multiple Input Multiple Output (MIMO) transmissions with precoding may also be supported. MIMO configurations in the DL may support up to eight transmit antennas with multi-layer DL transmissions up to eight streams and up to two streams per user equipment. Multi-layer transmissions with up to 2 streams per user equipment may be supported. Aggregation of multiple cells may be supported with up to eight serving cells. Alternatively, NR may support a different air interface, other than an OFDM-based air interface.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, NR or 5G RAT networks may be deployed.

In some implementations, two or more user equipment 120a-e (for example, illustrated as the user equipment 120a and the user equipment 120e) may communicate directly using one or more side link channels 124 (for example, without using a base station 110 as an intermediary to communicate with one another). For example, the user equipment 120a-e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof In this case, the user equipment 120a-e may perform scheduling operations, resource selection operations, as well as other operations described elsewhere herein as being performed by the base station 110a

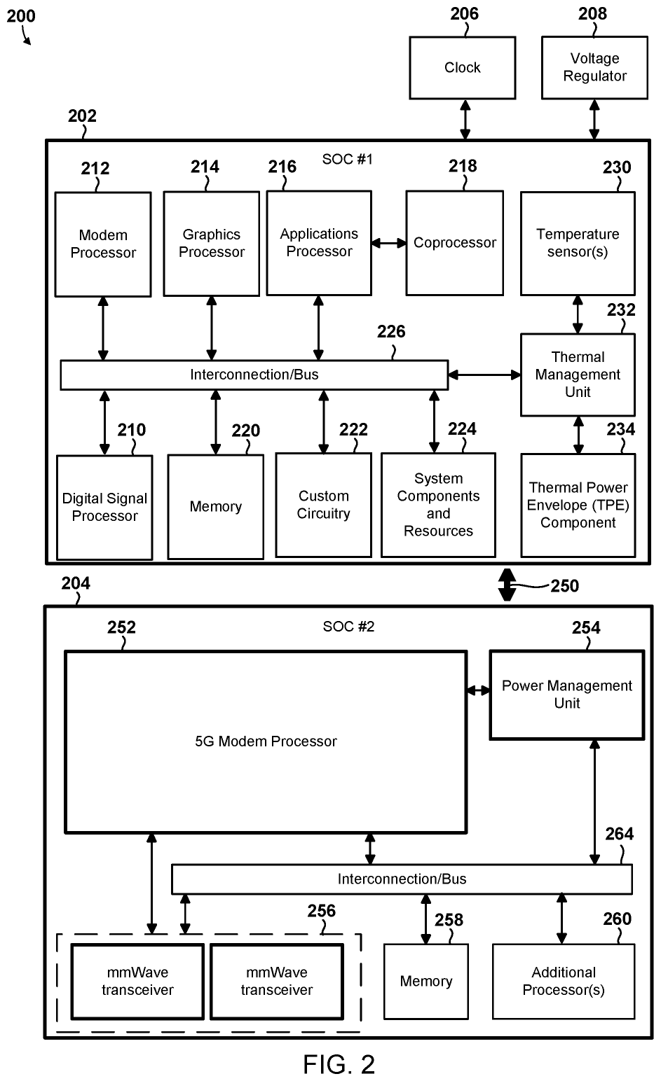

Various embodiments may be implemented on a number of single processor and multiprocessor computer systems, including a system-on-chip (SOC) or system in a package (SIP). FIG. 2 illustrates an example computing system or SIP 200 architecture that may be used in user equipment implementing the various embodiments.

With reference to FIGS. 1 and 2, the illustrated example SIP 200 includes a two SOCs 202, 204, a clock 206, and a voltage regulator 208. In some embodiments, the first SOC 202 operate as central processing unit (CPU) of the user equipment that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

One or both of the first and second SOC's 202, 204 may include multiple codecs implemented within one or more processors, such a DSP 210, a coprocessor 218, a 5G modem processor 252, another processor 260 and/or in custom circuitry. Typically, different RATs (e.g., 2G, 3G, 4G, 3GPP LTE, 5G, NR, GSM, CDMA, WCDMA, WiMAX, TDMA, etc.) involve different codecs. To provide the capability of supporting different RATs, the first and second SOC's 202, 204 may be configured to use the codecs associated with the particular RAT supporting a voice call. Various codecs may be implemented in software executing in a processor, in dedicated circuitry, and/or in a combination of software and dedicated circuitry, which may depend upon the particular codec.

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a user equipment. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

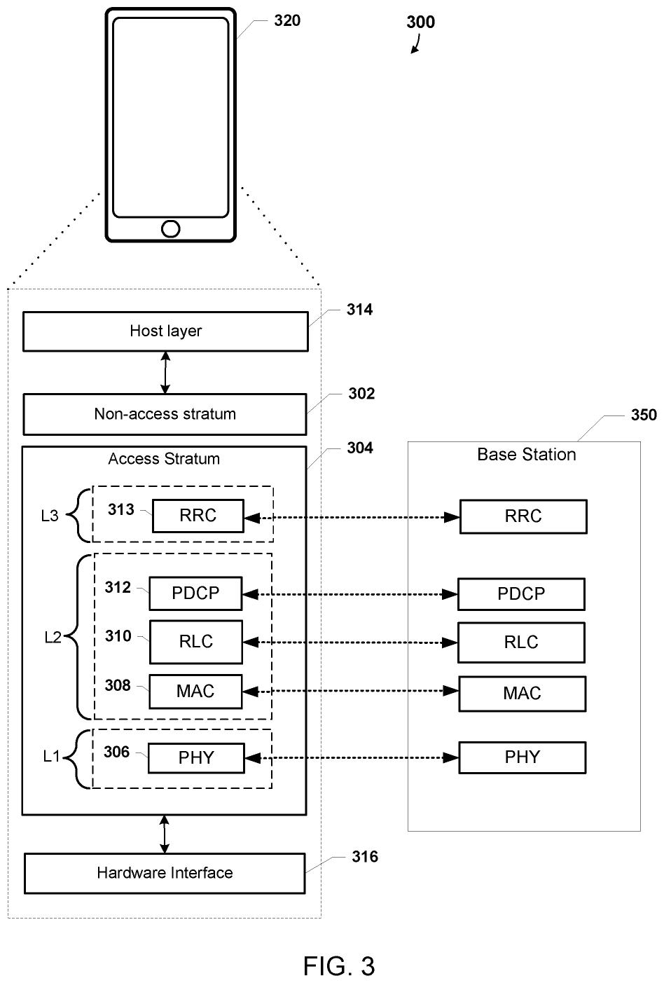

FIG. 3 illustrates an example of a software architecture 300 including a radio protocol stack for the user and control planes in wireless communications between a base station 350 (e.g., the base station 110a) and a user equipment 320 (e.g., the user equipment 120a-120e, 200). With reference to FIGS. 1-3, the user equipment 320 may implement the software architecture 300 to communicate with the base station 350 of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) user equipment, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the user equipment (e.g., SIM(s) 204) and its core network 140. The AS 304 may include functions and protocols that support communication between a SIM(s) (e.g., SIM(s) 204) and entities of supported access networks (e.g., a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface. Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the user equipment 320 and the base station 350 over the physical layer 306. In the various embodiments, Layer 2 may include a media access control (MAC) sublayer 308, a radio link control (RLC) sublayer 310, and a packet data convergence protocol (PDCP) 312 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In various embodiments, the RRC sublayer 313 may provide functions INCLUDING broadcasting system information, paging, and establishing and releasing an RRC signaling connection between the user equipment 320 and the base station 350.

In various embodiments, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the user equipment 320. In some embodiments, application-specific functions provided by the at least one host layer 314 may provide an interface between the software architecture and the general-purpose processor 206.

In other embodiments, the software architecture 300 may include one or more higher logical layer (e.g., transport, session, presentation, application, etc.) that provide host layer functions. For example, in some embodiments, the software architecture 300 may include a network layer (e.g., IP layer) in which a logical connection terminates at a packet data network (PDN) gateway (PGW). In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more radio frequency (RF) transceivers).

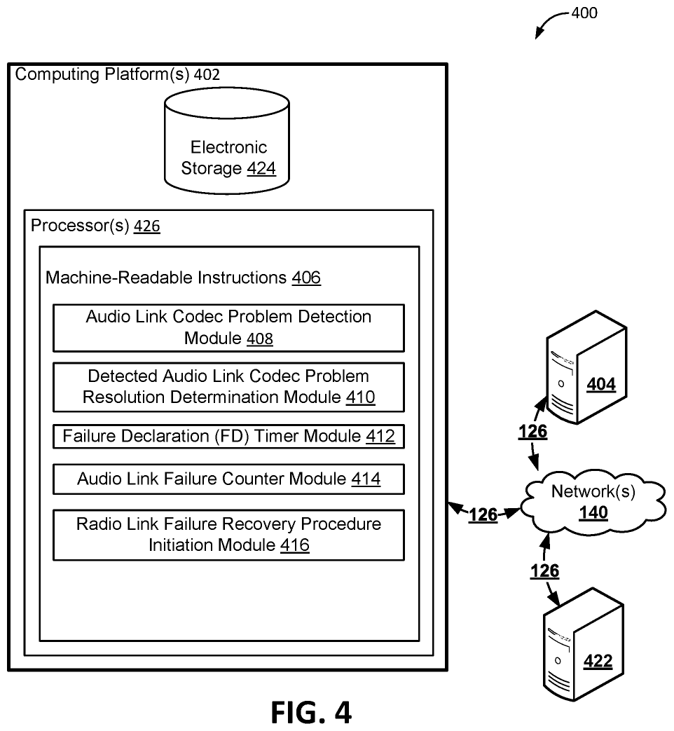

FIG. 4 is a component block diagram illustrating a system 400 configured for recovering a communication audio link of a user equipment with a communication network in accordance with various embodiments. In some embodiments, system 400 may include one or more computing platforms 402 and/or one or more remote platform(s) 404. With reference to FIGS. 1-4, computing platform(s) 402 may include a base station (e.g., the base station 110, 350) and/or a user equipment (e.g., the user equipment 120a-120e, 200, 320). Remote platform(s) 404 may include a base station (e.g., the base station 110, 350) and/or a user equipment (e.g., the user equipment 120a-120e, 200, 320). The system 400 may be configured to operate using any RAT, including 2G, 3G, 4G, 3GPP LTE, 5G, NR, GSM, CDMA, WCDMA, WiMAX, TDMA, etc. in both circuit switch and packet switch domains. Further, the system may be configured to detect and respond to audio link codec problems that may arise during an inter-RAT handover or transition, as well as in response to inter-codec rate changes, codec bypass, signal variations and “fallback” procedures in which the user equipment and/or the network switches from packet switch communications to circuit switch communications in response to network limitations.

Computing platform(s) 402 may be configured by machine-readable instructions 406. Machine-readable instructions 406 may include one or more instruction modules. The instruction modules may include computer program modules, such as an audio link codec problem detection module 408, a detected audio link codec problem resolution determination module 410, a failure declaration timer module 412, an audio link failure counter module 414, a radio link failure recovery procedure initiation module 412, and/or other instruction modules.

The audio link codec problem detection module 408 may be configured to detect, by a processor 426 (e.g., 212, 216, 252 or 260) of the user equipment, when a potential audio link codec problem occurs for an active voice call based on an audio link pattern. More than one type of potential audio link codec problem may be detected. For example, the potential audio link codec problems that may be detected include a repeated homing sequence, other repetitive data sequences, durations when no data is received due to data/packet loss, receipt of undecodable patterns in vocoder data, and jitter in the vocoder output.

The detected audio link codec problem resolution determination module 410 may be configured to determine, by the processor, whether the detected potential audio link codec problem(s) is/are resolved. The detected audio link codec problem resolution determination module 410 may be a separate module or may be part of the audio link codec problem detection module 408 described above.

The failure declaration timer module 412 may provide a timer-type function for measuring how long one or more detected potential audio link codec problems persist. The failure declaration timer may be a count-up or a count-down timer. As either a count-up or count-down timer, once a predetermined amount of time elapses, the timer will expire. The failure declaration timer may be started or initialized in response to a detection of any potential audio link codec problem and may expire after a duration that may be determined based on testing, experiments or network analysis. As a non-limiting example, the failure declaration timer may be configured to expire after about 40 ms. The failure declaration timer (“FD timer” in the drawings) may be used to determine whether the detected potential audio link codec problem persists longer than a typical duration to resolve the detected problem, and if the problem or problems persist too long or repeats a threshold number of times, remedial action may be taken by triggering the RLF procedure. In various embodiments, the failure declaration timer may be initiated (e.g., started) in response to detecting any of the various types of potential audio link codec problems. In some embodiments, the failure declaration timer may be a different duration for different types of potential audio link codec problems.

In some embodiments, the current audio link may not be declared a failure until the failure declaration timer expires a number of times in a row. In this way, the failure declaration timer may include a plurality of timers run one after the other in an uninterrupted series. In embodiments that include a plurality of failure declaration timers, expiration of the last in a series of the plurality of timers may represent the final expiration of the failure declaration timer, at which point a failure declaration may be made with regard to the current audio link. The number of times the failure declaration timer is run, for declaring the failure of the current audio link (i.e., the number of consecutive times the failure declaration timer is run) may be based on the type of the detected potential audio link codec problem.

The audio link failure counter module 414 may be configured to keep a tally of how many times the failure declaration timer expires before the resolution of all detected audio link codec problems. For example, the audio link failure counter module 414 may increment the audio link failure counter (i.e., increase the count by one) in response to expiration of each of the series of failure declaration timers. In addition, the audio link failure counter module 414 may be configured to decrement the counter (i.e., decrease the count by one) in response to determining that all detected PALC problems have been resolved before expiration of the failure declaration timer. In this way, the audio link failure counter may be incremented (i.e., the count increased) in response to expiration of each failure declaration timer, but may also be decremented (i.e., the count decreased) if the detected PALC problem(s) is/are resolved. The audio link failure counter may have a lower limit of zero, so the value of the audio link failure counter may not be negative. In addition, the audio link failure counter may have an upper limit in the form of an audio link failure (ALF) counter threshold. As a non-limiting example, the ALF counter threshold may be values between about 50 and about 100, or more. The ALF counter threshold may be selected or set such that once the audio link failure counter exceeds the ALF counter threshold, it is unlikely that the current audio link will be recovered. Thus, the processor may be configured to start the radio link failure recover procedure in response to the ALF counter reaching or exceeding the ALF counter threshold.

The radio link failure (RLF) recovery procedure initiation module 416 may be configured to initiate a radio link failure recovery procedure. Initiation of the radio link failure recovery procedure may be in response to determining the detected potential audio link codec problem is not resolved before expiration of the failure declaration timer, if a single timer is used, or before the audio link failure counter reaches the ALF counter threshold if a series of failure declaration timers is used. The failure declaration timer may include a separate failure declaration timer for each detected potential audio link codec problem and the initiation of the radio link failure recovery procedure may be in response to expiration of the first of the separate failure declaration timers.

The computing platform(s) 402 may include electronic storage 424, peripheral device(s) 422, one or more processors 426, and/or other components. Computing platform(s) 402 may include communication lines, or ports to enable the exchange of information with the peripheral device(s) 422, a network and/or other computing systems. The illustration of computing device(s) 110 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of vehicle computing systems operating together as computing platform(s) 402.

Electronic storage 424 may include non-transitory storage media that electronically stores information. The electronic storage media of electronic storage 402 may include one or both of system storage that is provided integrally (i.e., substantially non-removable) with computing platform(s) 402 and/or removable storage that is removably connectable to computing platform(s) 402 via, for example, a port (e.g., a universal serial bus (USB) port, a firewire port, etc.) or a drive (e.g., a disk drive, etc.). Electronic storage 424 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 424 may include one or more virtual storage resources (e.g., cloud storage, a virtual private network, and/or other virtual storage resources). Electronic storage 424 may store software algorithms, information determined by processor(s) 426, information received from computing platform(s) 402, information received from other computing platform(s), and/or other information that enables computing platform(s) 402 to function as described herein.

The peripheral device(s) 422 may comprise any external device that provides input and/or output for the computing platform(s) 402. Some peripheral device(s) 422 may be both input and output devices, while others may provide either input or output. A remote microphone, keyboard, or mouse are examples of an input peripheral devices, while a monitor, printer, or personal audio output device are examples of output peripheral devices. Some peripheral devices, such as personal audio output devices or external hard drives, provide both input and output. For example, some personal audio devices like headphones, earpieces, ear buds, or similar devices include both speakers and microphones, making them both input and output devices. As used herein, a personal audio output device is a peripheral device(s) that includes at least the output functionality (i.e., a speaker), but may also include input functionality (i.e., a microphone).

The peripheral device(s) 422 and/or remote platform(s) 404 may each also include one or more processors configured to execute computer program modules configured by machine-readable instructions, such as the machine-readable instructions 406. In addition, peripheral device(s) 422 and/or remote platform(s) 404 may be communicatively coupled to the computing platform(s) 402 via the core network 140 and wired or wireless communication link(s) 126.

Remote platform(s) 404 may include sources of information outside of system 400, external entities participating with the system 400, and/or other resources. For example, remote platform(s) 404 may include computing devices associated with financial institutions, government agencies, public or private companies, and other entities. In some embodiments, some or all of the functionality attributed herein to remote platform(s) 404 may be provided by resources included in system 400.

In some embodiments, computing platform(s) 402, peripheral device(s) 422, remote platform(s) 404, and other external resources 408 may communicate with one another via wired or wireless networks. Additionally, the computing device(s) 110, peripheral device(s) 422, and/or remote system(s) 406 may be connected to wireless communication networks that provide access to external resources 408. For example, such electronic communication links may be established, at least in part, via a network such as the Internet and/or other networks. It will be appreciated that this is not intended to be limiting, and that the scope of this disclosure includes embodiments in which computing device(s) 110, peripheral device(s) 422, remote system(s) 406, and/or other external resources 408 may be operatively linked via some other communication media.

Processor(s) 426 may be configured to provide information processing capabilities in computing platform(s) 402. As such, processor(s) 426 may include one or more of a digital processor, an analog processor, a digital circuit designed to process information, an analog circuit designed to process information, a state machine, and/or other mechanisms for electronically processing information. Although processor(s) 426 is shown in FIG. 4 as a single entity, this is for illustrative purposes only. In some embodiments, processor(s) 426 may include a plurality of processing units. These processing units may be physically located within the same device, or processor(s) 410 may represent processing functionality of a plurality of devices operating in coordination. Processor(s) 426 may be configured to execute modules 408, 410, 412, 414, and/or 416, and/or other modules. Processor(s) 426 may be configured to execute modules 408, 410, 412, 414, and/or 416, and/or other modules by software; hardware; filmware; some combination of software, hardware, and/or filmware; and/or other mechanisms for configuring processing capabilities on processor(s) 426. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, and/or 416 are illustrated in FIG. 4 as being implemented within a single processing unit, in embodiments in which processor(s) 410 includes multiple processing units, one or more of modules 408, 410, 412, 414, and/or 416 may be implemented remotely from the other modules. The description of the functionality provided by the different modules 408, 410, 412, 414, and/or 416 described below is for illustrative purposes, and is not intended to be limiting, as any of modules 408, 410, 412, 414, and/or 416may provide more or less functionality than is described. For example, one or more of modules 408, 410, 412, 414, and/or 416 may be eliminated, and some or all of its functionality may be provided by other ones of modules 408, 410, 412, 414, and/or 416. As another example, processor(s) 410 may be configured to execute one or more additional modules that may perform some or all of the functionality attributed below to one of modules 408, 410, 412, 414, and/or 416.

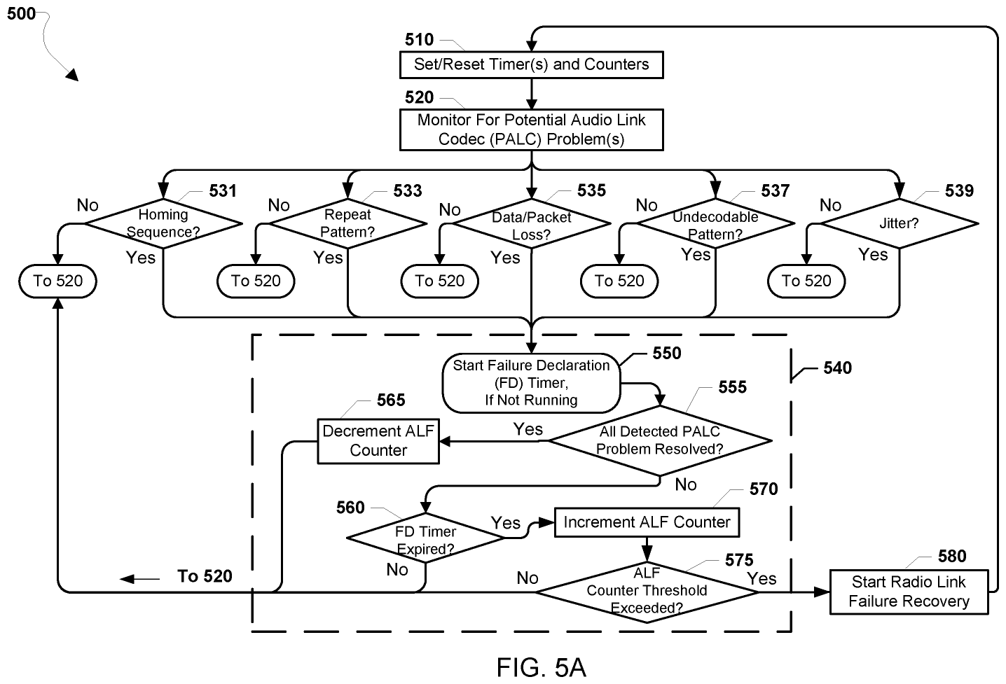

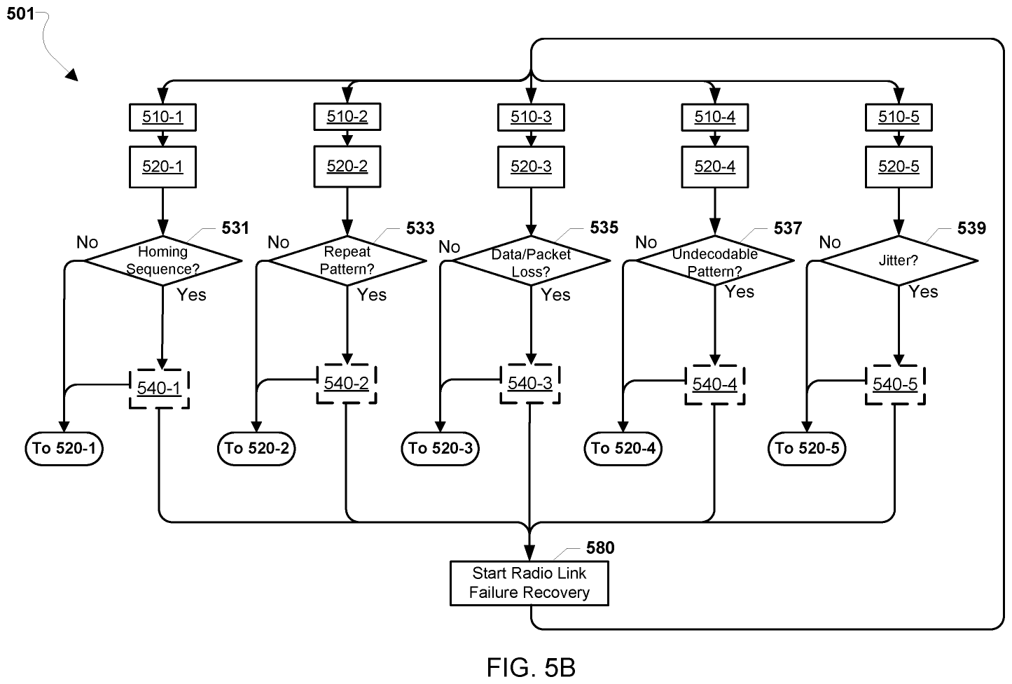

FIGS. 5A and/or 5B are process flow diagrams of example methods 500 and 501 of recovering a communication audio link of a user equipment with a communication network according to various embodiments. With reference to

FIGS. 1-5A, the method 500 may be implemented by a processor (such as 212, 216, 252 or 260) of a user equipment (such as the user equipment 120a-120e, 200, 320). Further, the method 500 may be implemented in user equipment operating using any RAT, including 2G, 3G, 4G, 3GPP LTE, 5G, NR, GSM, CDMA, WCDMA, WiMAX, TDMA, etc. in both circuit switch and packet switch domains.

In block 510, following the initiation of a new active voice call or the reestablishment of an audio communication link of an existing voice call (e.g., when calls are switched to a new/different base station or an RLF recovery procedure is initiated), the processor may set or reset the timer(s) (i.e., the failure declaration timer(s)) and counter(s) (i.e., the audio link failure counter(s) of the timer(s)). In particular, the processor may set any timers to zero and similarly reset any counters to zero.

In block 520, the processor (e.g., using the audio link codec problem detection module 408) may monitor various audio link characteristics for potential audio link codec problems during an active voice call by monitoring for certain audio link patterns. Patterns indicating potential audio link codec problems may include a repeated homing sequence, other repetitive data sequences, durations when no data is received due to data/packet loss, receipt of undecodable patterns in vocoder data, and jitter in the vocoder output. An audio link codec problem may arise during or following a change in radio access technology (RAT). As different RATs, such as 2G, 3G, 4G, 5G, GSM, etc., typically use different codecs, audio link codec problems can occur during or following an inter-RAT handover. For example, audio link codec problems may occur during any combination of a change in inter-code rate, a codec bypass, a handover from one network to another, changes in network configurations, signal variations, or a “fallback” procedure in which the user equipment and/or network shifts the active voice call from a packet switch network to a circuit switched network due to network limitations. Therefore, in some embodiments the operations in block 520 may be performed in response to or more frequently following an inter-RAT handover.

Homing sequences are generally transmitted by a network to locate UEs in relation to local base stations. Homing sequences are special vocoder packets that will put the vocoder at the receiver side into a “clean” state. On playing those packets, the vocoder output will result in any sound being produced by the receiver. Homing sequences may be sent on the transmitting side when there are no valid speech packets to send, such as when a transmission channel has been allocated to a UE by the call has not yet been connected.

Homing sequences are unique for each type of vocoder, and thus homing sequences may be sent in response to changing from one type of vocoder to another. The network may end up repeatedly sending the same homing sequence in an attempt to adapt the UE to new codec rate changes. Other repetitive data sequences may be received for various reasons.

Data or packet loss may occur when one or more packets of data travelling across a communication network fail to reach their destination (e.g., the UE). Data and/or packet loss may be either caused by errors in data transmission or network congestion. Undecodable patterns in vocoder data may be received at the UE, such as when link quality falls to or below a minimum or there is interference or noise affecting the link. Jitter may be associated with receiving audio packets that are delayed or received as a burst due to network congestion.

In determination block 531, the processor may determine whether a repeated homing sequence is received or detected. For example, the processor may compare a most recently received homing sequence to one or more previously received homing sequences within a predetermined interval of time (e.g., the last 3-5 seconds) and if the current homing sequence is the same as the most recent previously received homing sequences, the processor may register that a repeated homing sequence has been received. As noted above, homing sequences sent/received depend upon the codec in use, and may be transmitted for a number of reasons, including when there are no valid speech packets to send. Since audio packets are sent/received every 20 ms, the same homing sequence may be sent/received during normal operations when no sound is to be produced at the receiver. Thus, the processor may be configured to recognize that a repeating homing sequence indicates a potential audio link codec problem when the number of repeated sequences exceeds a threshold value, which may be set by a communication network operator. In response to the processor determining the received homing sequence is not a repeat of other recently received homing sequences or no homing sequence is received (i.e., determination block 531=“No”), the processor may return to block 520 to detect when any potential audio link codec problem occurs for an active voice call based on detected audio link patterns.

In determination block 533, the processor may determine whether a repeated data sequence pattern is received. For example, the processor may compare a most recently received data sequence pattern to one or more previously received data sequences patterns within a predetermined interval of time (e.g., the last 3-5 seconds) and if the currently received data sequence pattern is the same as a threshold number of recent previously received data sequence patterns, the processor may register that a repeating data sequence pattern has been detected. In response to the processor determining the received data sequence pattern is not a repeating data sequence pattern (i.e., determination block 533=“No”), the processor may return to block 520 to detect when any potential audio link codec problem occurs for an active voice call based on detected audio link patterns.

In determination block 535, the processor of the UE, may determine whether data or packet loss has been detected. For example, the processor may determine whether a measure of received data and/or packets drop below a predetermined threshold, below which represents detected data and/or packet loss is occurring. The packet loss threshold may depend on the particular RAT and may be configured by the communication network operator. In response to the processor determining that no data and/or packet loss is occurring (i.e., determination block 535=“No”), the processor may return to block 520 to detect when any potential audio link codec problem occurs for an active voice call based on detected audio link patterns.

In determination block 537, the processor of the UE, may determine whether an undecodable data sequence pattern has been detected. For example, if all data packets have been received or recovered, but the codec is unable to decode the packet data into a sequence that can be converted into audio data, this indicates that the codec used by the sending UE to encode audio data is different from the codec that the receiving UE is using in attempting to decode the received data. In response to the processor not detecting an undecodable data sequence pattern or determining that no undecodable data sequence pattern has been detected (i.e., the received data is being decoded and thus determination block 537=“No”), the processor may return to block 520 to detect when any potential audio link codec problem occurs for an active voice call based on detected audio link patterns.

In determination block 539, the processor of the UE, may determine whether jitter has been detected. In response to the processor not detecting jitter or determining that no jitter has been detected (i.e., determination block 539=“No”), the processor may return to block 520 to detect when any potential audio link codec problem occurs for an active voice call based on detected audio link patterns.

In response to the processor determining that a repeated homing sequence has been received (i.e., determination block 531=“Yes”), that a repeated data sequence pattern has been received (i.e., determination block 533=“Yes”), that data and/or packet loss is occurring (i.e., determination block 535=“Yes”), that an undecodable data sequence pattern has been detected (i.e., determination block 537=“Yes”), and/or that jitter has been detected (i.e., determination block 539=“Yes”), the processor may start the failure declaration timer in block 550, if the failure declaration timer is not already running. In some embodiments, the processor may start a failure declaration timer associated with the type of problem detected.

Determination blocks 531, 533, 535, 537, and 539 may each occur independent of one another, such that some or all of the determinations may overlap and/or occur at the same or separate instances. Thus, the process steps of the method 500 may effectively act like at least five separate cycles of the process running simultaneously (i.e., one cycle for each PALC problem being detected).

In virtual determination block 540 (denoted with dashed lines), the processor may determine whether to continue using the existing audio link and continue detecting PALC problems (i.e., return to block 520) or whether to start a radio link failure recovery procedure in block 580. Further details of the sub-blocks and sub-determination blocks of the virtual determination block 540 are described below with reference to blocks 550, 565, and 570 and determination blocks 555, 560, and 575. Since each of the above-described determination blocks 531, 533, 535, 537, and 539 may run separately and enter the virtual determination block 540 upon a positive determination (i.e., the determination=“Yes”), separate determinations may be made simultaneously or consecutively within virtual determination block 540 relating to the different PALC problems, respectively.

In block 550, in response to the UE processor detecting one or more of a repeated homing sequence, other repetitive data sequences, data and/or packet loss, receipt of undecodable patterns, and/or jitter, the processor (e.g., using the failure declaration timer module 412) may start a failure declaration timer (e.g., the system components and resources 224), if the failure declaration timer is not already running. The failure declaration timer may already be running from a previously detected PALC problem, which may have been the same or a different PALC problem, that initiated the start of the failure declaration timer in block 550.

In determination block 555, the processor (e.g., using the detected audio link codec problem resolution determination module 410) may determine whether all of the detected PALC problems (i.e., from determination blocks 531, 533, 535, 537, and 539) have resolved. Following determination blocks 531, 533, 535, 537, and 539, one to five different PALC problems may have been detected, but regardless of how many different PALC problems were detected, the processor in determination block 555 determines whether all detected PALC problems are resolved in determination block 555.

In response to determining that all detected PALC problems are resolved (i.e., determination block 555=“Yes”), the processor may decrement an ALF counter (e.g., using the audio link failure counter module 414) in block 565 and return to monitoring for potential audio link codec problems in block 520 as described.

In response to determining that all detected PALC problems are not resolved (i.e., determination block 555=“No”), the processor may determine whether the failure declaration timer (i.e., the failure declaration timer started or already running from block 550) has expired in block 560.

In response to determining the failure declaration timer has expired (i.e., determination block 560 =“Yes”), the processor may increment the ALF counter (e.g., using the audio link failure counter module 414) in block 570.

In determination block 575, the processor may determine whether ALF counter exceeds an ALF counter threshold (e.g., using the audio link failure counter module 414) in block 575. In response to determining that the ALF counter exceeds the ALF counter threshold (i.e., determination block 575=“Yes”), the processor may start the radio link failure recovery procedure in block 580. Once a new audio communication link has been established through the radio link failure recovery procedure, the processor may again reset the failure declaration timer(s) and the ALF counter(s) to zero in block 510.

In response to determining that the failure declaration timer has not expired (i.e., determination block 560=“No”), following the decrement of the ALF counter in block 565, or in response to the processor determining that the ALF counter has not exceeded the ALF counter threshold (i.e., determination block 575=“No”), the processor may return to monitoring for potential audio link codec problems in block 520 as described.

The operations of the method 500 may be performed continuously, periodically, or episodically, during an active voice call.

FIG. 5B illustrates an alternative embodiment method 501 in which separate failure declaration operations may be performed for each of the PALC problems. With reference to FIGS. 1-5B, the method 501 may be implemented by a processor (such as 212, 216, 252 or 260) of a user equipment (such as the user equipment 120a-120e, 200, 320).

In the method 501, any one of the PALC problems may independently trigger the start of the radio link failure recovery procedure in block 580. In this way, separately failure declaration operations may be performed for each of the PALC problems, including a repeated homing sequence, other repetitive data sequences, durations when no data is received due to data/packet loss, receipt of undecodable patterns in vocoder data, and jitter in the vocoder output.

In the method 501: the operations associated with repeated homing sequence problems are denoted with a hyphen followed by the number “-1”; the operations associated with other repetitive data sequences problems are denoted with a hyphen followed by the number “-2”; the operations associated with problems of durations when no data is received due to data/packet loss are denoted with a hyphen followed by the number “-3”; the operations associated with problems of receipt of undecodable patterns in vocoder data are denoted with a hyphen followed by the number “-4”; and the operations associated jitter problems are denoted with a hyphen followed by the number “-5”. Thus, operations in determination block 540-1 and blocks 510-1 and 520-1 are analogous to the operations of determination block 540 and blocks 510 and 520 of the method 500 described with reference to FIG. 5A, but limited to repeated homing sequence problems. Similarly, operations in determination block 540-2 and blocks 510-2 and 520-2 are analogous to the operations of determination block 540 and blocks 510 and 520 of the method 500 described with reference to FIG. 5A, but limited to other repetitive data sequences problems. Similarly, operations in determination block 540-3 and blocks 510-3 and 520-3 are analogous to the operations of determination block 540 and blocks 510 and 520 of the method 500 described with reference to FIG. 5A, but limited to data/packet loss problems. Similarly, operations in determination block 540-4 and blocks 510-4 and 520-4 are analogous to the operations of determination block 540 and blocks 510 and 520 of the method 500 described with reference to FIG. 5A, but limited to undecodable pattern problems. Similarly, operations in determination block 540-5 and blocks 510-5 and 520-5 are analogous to the operations of determination block 540 and blocks 510 and 520 of the method 500 described with reference to FIG. 5A, but limited to jitter problems.

The operations of the method 501 may be performed continuously, periodically, or episodically, during an active voice call.

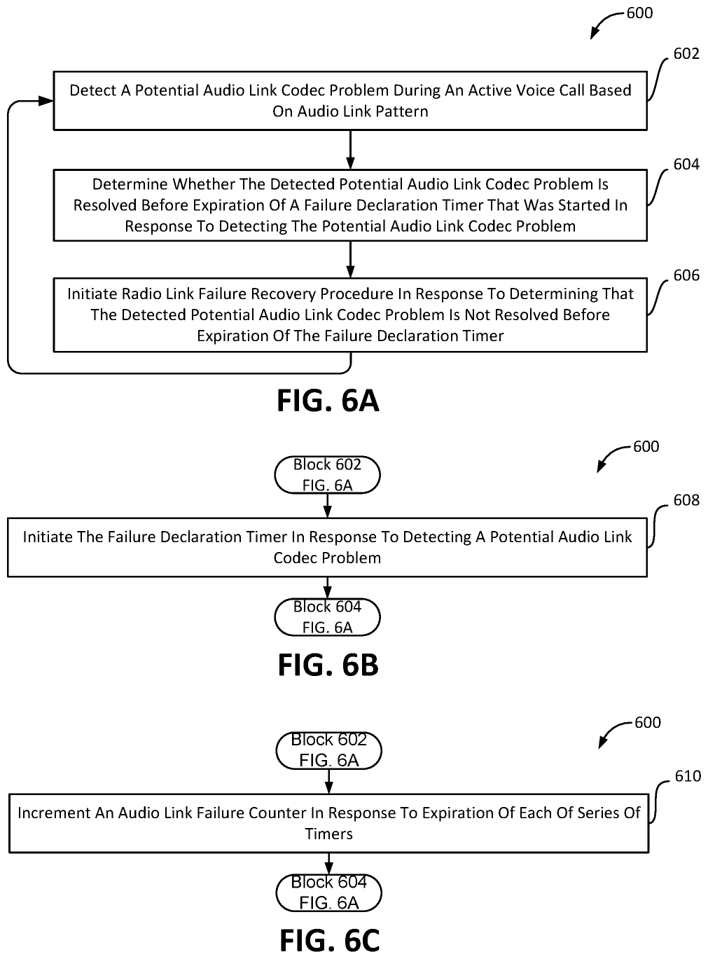

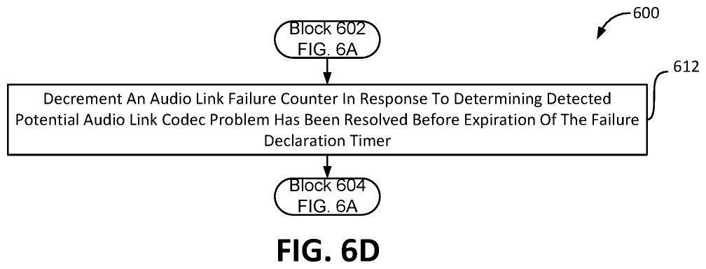

FIGS. 6A, 6B, 6C, and/or 6D illustrate(s) operations of a method 600 for recovering a communication audio link of a user equipment with a communication network in accordance with various embodiments. The operations of the method 600 presented below are intended to be illustrative. In some embodiments, the method 600 may be accomplished with one or more additional operations not described, and/or without one or more of the operations discussed. Additionally, the order in which the operations of the method 600 are illustrated in FIGS. 6A, 6B, 6C, and/or 6D and described below is not intended to be limiting.

The method 600 may be implemented in one or more processors of a user equipment, such as a digital processor, an analog processor, a digital circuit designed to process information, an analog circuit designed to process information, a state machine, and/or other mechanisms for electronically processing information. The one or more processors may include one or more devices executing some or all of the operations of method 600 in response to instructions stored electronically on an electronic storage medium. The one or more processors may include one or more devices configured through hardware, firmware, and/or software to be specifically designed for execution of one or more of the operations of method 600. For example, with reference to FIGS. 1-6A, 6B, 6C, and/or 6D, the operations of the method 600 may be performed by a processor (e.g., 202 or 204) of a user equipment (e.g., 120a-120e, 200, 320).

FIG. 6A illustrates the method 600 that may be performed by the processor of a user equipment for recovering a communication audio link of a user equipment with a communication network in some embodiments.

In block 602, the processor may perform operations including detecting a potential audio link codec (PALC) problem during an active voice call based on an audio link pattern. For example, the processor may use the audio link codec problem detection module (e.g., 408) to determine whether one or more PALC problem is detected. For example, in block 602 the processor may detect any of a repeating homing sequence, repeating data sequences, threshold data or packet loss, receipt of undecodable patterns in vocoder data, or jitter in vocoder output.

In block 604, the processor may perform operations including determining whether the detected potential audio link codec problem is resolved before expiration of a failure declaration timer that was started in response to detecting the potential audio link codec problem. For example, the processor may use the failure declaration timer module (e.g., 412) to determine whether a detected PALC problem has persisted longer than the predetermined duration of the failure declaration timer. In some embodiments, if the failure declaration timer has not expired, the processor may use the detected audio link codec problem resolution determination module (e.g., 410) to determine whether detected PALC problems have been resolved. In some embodiments, the failure declaration timer may include a plurality of timers run one after the other in an uninterrupted series, and expiration of the failure declaration timer may occur when a last in the series of the plurality of timers expires. In some embodiments, the failure declaration timer may include a plurality of timers run one after the other in an uninterrupted series, and expiration of the failure declaration timer may occur when any one of the plurality of timers expires.

In block 606, the processor may perform operations including initiating a radio link failure recovery procedure in response to determining the detected potential audio link codec problem is not resolved before expiration of the failure declaration timer. For example, the processor may use the radio link failure recovery procedure initiation module (e.g., 416) to initiate the radio link failure recovery procedure. In some embodiments in which the failure declaration timer includes a plurality of timers run one after the other in an uninterrupted series, the processor may initiate the radio link failure recovery procedure in response to expiration of a last in the series of the plurality of timers expires. In some embodiments in which the failure declaration timer includes a plurality of timers run one after the other in an uninterrupted series, the processor may initiate the radio link failure recovery procedure in response to expiration of any one of the plurality of timers expires. In some embodiments, the failure declaration timer may include a separate timer for each type of detected potential audio link codec problem, in which case the processor may initiate the radio link failure recovery procedure in response to expiration of any of the separate timers.

Following the operations in block 606, the processor may once again perform the operations in block 602 as described.

FIG. 6B illustrates an additional operation that may be performed by the processor of the user equipment as part of the method 600 for recovering a communication audio link of a user equipment with a communication network in some embodiments.

In block 608, following the operations in block 602, the processor may perform operations including initiating the failure declaration timer in response to detecting when the potential audio link codec problem occurs. For example, the processor may use the failure declaration timer module to initiate one or more failure declaration timers. In some embodiments, the failure declaration timer may include a plurality of timers and in block 608 the processor may initiate one of the plurality of failure declaration timers that is associated with the type of detected potential audio link codec problem. In some embodiments, the failure declaration timer may expire after a duration that depends on the type of potential audio link codec problem detected in block 602, in which case in addition to initiating the failure declaration timer, the processor may set the duration of the failure declaration timer based on the type of detected potential audio link codec problem.

Following the operations in block 608, the processor may perform the operations in block 604 as described with reference to FIG. 6A.

FIG. 6C illustrates an additional operation that may be performed by the processor of the user equipment as part of the method 600 for recovering a communication audio link of a user equipment with a communication network in some embodiments.

In block 610, the processor may perform operations including incrementing an audio link failure counter in response to expiration of each of a series of timers (e.g., failure declaration timers). For example, the processor may use the audio link failure counter module (e.g., 414) to increment the audio link failure counter. In some embodiments, initiating the radio link failure recovery procedure, in block 606, may be further in response to the audio link failure counter reaching a threshold (e.g., the ALF counter threshold) such as by performing the operations determination block 575 and block 580 of the method 500 as described with reference to FIG. 5A.

Following the operations in block 610, the processor may perform the operations in block 604 as described with reference to FIG. 6A.

FIG. 6D illustrates an additional operation that may be performed by the processor of the user equipment as part of the method 600 for recovering a communication audio link of a user equipment with a communication network in some embodiments.

In block 612, the processor may perform operations including decrementing the audio link failure counter in response to determining that a detected potential audio link codec problem has been resolved before expiration of the failure declaration timer. For example, the processor may use the failure declaration timer module (e.g., 412) to determine whether the detected potential audio link codec problem has persisted longer than the predetermined amount of time of the failure declaration timer. In addition, the processor may use the audio link failure counter module (e.g., 414) to decrement the ALF counter if the failure declaration timer has not expired.

Following the operations in block 612, the processor may perform the operations in block 604 as described with reference to FIG. 6A.

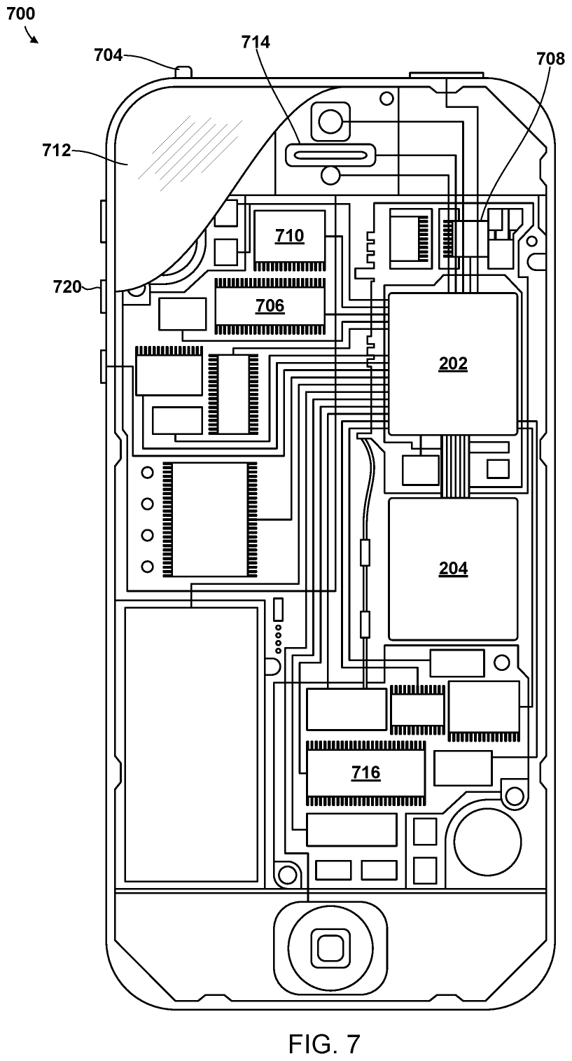

Various embodiments may be implemented on a variety of user equipment (e.g., UE 120a-120e, 200, 320), an example of which is illustrated in FIG. 7 in the form of a smartphone 700. The smartphone 700 may include a first SOC 202 (e.g., a SOC-CPU) coupled to a second SOC 204 (e.g., a 5G capable SOC). The first and second SOCs 202, 204 may be coupled to internal memory 706, 716, a display 712, and to a speaker 714. Additionally, the smartphone 700 may include an antenna 704 for sending and receiving electromagnetic radiation that may be connected to a wireless data link and/or cellular telephone transceiver 708 coupled to one or more processors in the first and/or second SOCs 202, 204. Smartphones 700 typically also include menu selection buttons or rocker switches 720 for receiving user inputs.

A typical smartphone 700 also includes a sound encoding/decoding (codec) circuit 710, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 708 and codec 710 may include a digital signal processor (DSP) circuit (not shown separately).

The processors of the wireless network computing device 800 and the smart phone 700 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SOC 204 dedicated to wireless communication functions and one processor within an SOC 202 dedicated to running other applications. Typically, software applications may be stored in the memory 706, 716 before they are accessed and loaded into the processor. The processors may include internal memory sufficient to store the application software instructions.

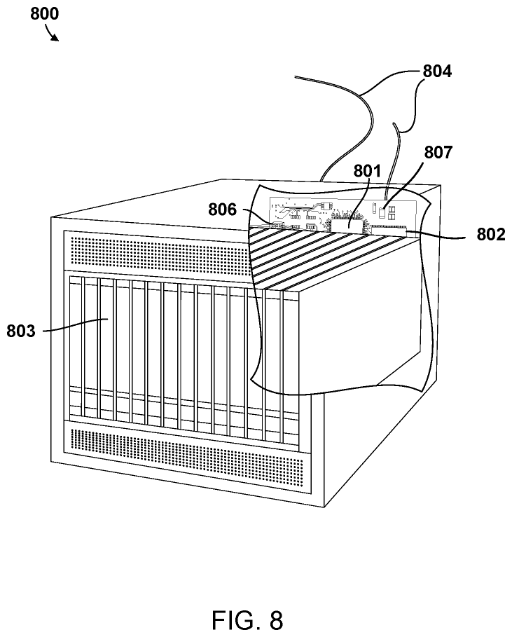

Various embodiments may be implemented on a variety of wireless network devices, an example of which is illustrated in FIG. 8 in the form of a wireless network computing device 800 functioning as a network element of a communication network, such as a base station. Such network computing devices may include at least the components illustrated in FIG. 8. With reference to FIGS. 1-8, the network computing device 800 may typically include a processor 801 coupled to volatile memory 802 and a large capacity nonvolatile memory, such as a disk drive 803. The network computing device 800 may also include a peripheral memory access device such as a floppy disc drive, compact disc (CD) or digital video disc (DVD) drive 806 coupled to the processor 801. The network computing device 800 may also include network access ports 804 (or interfaces) coupled to the processor 801 for establishing data connections with a network, such as the Internet and/or a local area network coupled to other system computers and servers. The network computing device 800 may include one or more antennas 807 for sending and receiving electromagnetic radiation that may be connected to a wireless communication link. The network computing device 800 may include additional access ports, such as USB, Firewire, Thunderbolt, and the like for coupling to peripherals, external memory, or other devices.

As used in this application, the terms “component,” “module,” “system,” and the like are intended to include a computer-related entity, such as, but not limited to, hardware, filmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a user equipment and the user equipment may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 500, 501, and/or 600 may be substituted for or combined with one or more operations of the methods 500, 501, and/or 600.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed a processor of a user equipment device for recovering a communication audio link with a communication network, the method comprising:
detecting a potential audio link codec problem during an active voice call based on an audio link pattern;
determining whether the detected potential audio link codec problem is resolved before expiration of a failure declaration timer that was started in response to detecting the potential audio link codec problem; and
initiating a radio link failure recovery procedure in response to determining that the detected potential audio link codec problem is not resolved before expiration of the failure declaration timer.

2. The method of claim 1, wherein detecting a potential audio link codec problem during an active voice call based on an audio link pattern comprises detecting any of a repeating homing sequence, repeating data sequences, threshold data or packet loss, receipt of undecodable patterns in vocoder data, or jitter in vocoder output.

3. The method of claim 1, further comprising:
initiating the failure declaration timer in response to detecting a potential audio link codec problem.

4. The method of claim 1, wherein the failure declaration timer includes a plurality of timers run one after the other in an uninterrupted series and expiration of the failure declaration timer occurs when a last in the series of the plurality of timers expires.

5. The method of claim 4, wherein durations of each of the plurality of timers is based on a type of detected potential audio link codec problem associated with each timer.

6. The method of claim 4, further comprising:
incrementing an audio link failure counter in response to expiration of each of a series of timers, wherein initiating the radio link failure recovery procedure is performed further in response to the audio link failure counter reaching a threshold.

7. The method of claim 6, further comprising:
decrementing the audio link failure counter in response to determining that the detected potential audio link codec problem has been resolved before expiration of the failure declaration timer.

8. The method of claim 1, wherein the failure declaration timer is set to a duration that depends on a type of the detected potential audio link codec problem.

9. The method of claim 1, wherein the failure declaration timer includes a separate timer for each type of detected potential audio link codec problem and initiating the radio link failure recovery procedure is performed in response to expiration of any of the separate timers.

10. The method of claim 1, wherein detecting a potential audio link codec problem during the active voice call based on an audio link pattern comprises detecting the potential audio link codec problem following a change in a radio access technology (RAT) during the active voice call.

11. A user equipment device, comprising:
a processor configured with processor-executable instructions to:
detect a potential audio link codec problem during an active voice call based on an audio link pattern;
determine whether the detected potential audio link codec problem is resolved before expiration of a failure declaration timer that was started in response to detecting the potential audio link codec problem; and
initiate a radio link failure recovery procedure in response to determining that the detected potential audio link codec problem is not resolved before expiration of the failure declaration timer.

12. The user equipment device of claim 11, wherein the processor is further configured with processor-executable instructions to detect a potential audio link codec problem during an active voice call based on an audio link pattern by detecting any of a repeating homing sequence, repeating data sequences, threshold data or packet loss, receipt of undecodable patterns in vocoder data, or jitter in vocoder output.

13. The user equipment device of claim 11, wherein the processor is further configured with processor-executable instructions to:
initiate the failure declaration timer in response to detecting a potential audio link codec problem.

14. The user equipment device of claim 11, wherein the failure declaration timer includes a plurality of timers run one after the other in an uninterrupted series and expiration of the failure declaration timer occurs when a last in the series of the plurality of timers expires.

15. The user equipment device of claim 14, wherein durations of each of the plurality of timers is based on a type of detected potential audio link codec problem associated with each timer.

16. The user equipment device of claim 14, wherein the processor is further configured with processor-executable instructions to:
increment an audio link failure counter in response to expiration of each of a series of timers; and
initiate the radio link failure recovery procedure further in response to the audio link failure counter reaching a threshold.

17. The user equipment device of claim 16, wherein the processor is further configured with processor-executable instructions to:
decrement the audio link failure counter in response to determining that the detected potential audio link codec problem has been resolved before expiration of the failure declaration timer.

18. The user equipment device of claim 11, wherein the failure declaration timer is set to a duration that depends on a type of the detected potential audio link codec problem.

19. The user equipment device of claim 11, wherein:
the failure declaration timer includes a separate timer for each type of detected potential audio link codec problem; and
the processor is further configured with processor-executable instructions to initiate the radio link failure recovery procedure in response to expiration of any of the separate timers.

20. The user equipment device of claim 11, wherein the processor is further configured with processor-executable instructions to detect a potential audio link codec problem during the active voice call following a change in a radio access technology (RAT) during the active voice call.

21. A processor configured for use in a user equipment device, wherein the processor is configured with processor-executable instructions to:
detect a potential audio link codec problem during an active voice call based on an audio link pattern;
determine whether the detected potential audio link codec problem is resolved before expiration of a failure declaration timer that was started in response to detecting the potential audio link codec problem; and
initiate a radio link failure recovery procedure in response to determining that the detected potential audio link codec problem is not resolved before expiration of the failure declaration timer.

22. The processor of claim 21, wherein the processor is further configured with processor-executable instructions to detect a potential audio link codec problem during an active voice call based on an audio link pattern by detecting any of a repeating homing sequence, repeating data sequences, threshold data or packet loss, receipt of undecodable patterns in vocoder data, or jitter in vocoder output.

23. The processor of claim 21, wherein the processor is further configured with processor-executable instructions to:
initiate the failure declaration timer in response to detecting a potential audio link codec problem.

24. The processor of claim 21, wherein the failure declaration timer includes a plurality of timers run one after the other in an uninterrupted series and expiration of the failure declaration timer occurs when a last in the series of the plurality of timers expires.

25. The processor of claim 24, wherein durations of each of the plurality of timers is based on a type of detected potential audio link codec problem associated with each timer.

26. The processor of claim 24, wherein the processor is further configured with processor-executable instructions to:
increment an audio link failure counter in response to expiration of each of a series of timers; and
initiate the radio link failure recovery procedure further in response to the audio link failure counter reaching a threshold.

27. The processor of claim 26, wherein the processor is further configured with processor-executable instructions to:
decrement the audio link failure counter in response to determining that the detected potential audio link codec problem has been resolved before expiration of the failure declaration timer.

28. The processor of claim 21, wherein the failure declaration timer is set to a duration that depends on a type of the detected potential audio link codec problem.

29. The processor of claim 21, wherein:
the failure declaration timer includes a separate timer for each type of detected potential audio link codec problem; and
the processor is further configured with processor-executable instructions to initiate the radio link failure recovery procedure in response to expiration of any of the separate timers.

30. A user equipment device, comprising:
means for detecting a potential audio link codec problem during an active voice call based on an audio link pattern;
means for determining whether the detected potential audio link codec problem is resolved before expiration of a failure declaration timer that was started in response to detecting the potential audio link codec problem; and
means for initiating a radio link failure recovery procedure in response to determining that the detected potential audio link codec problem is not resolved before expiration of the failure declaration timer.
